(19) United States
(12) Patent Application Publication
(10) Pub. No.: US 2017/0045866 A1
(43) Pub. Date: Feb. 16, 2017

(54) METHODS AND APPARATUSES FOR OPERATING AN APPLIANCE

(71) Applicant: Xiaomi Inc., Beijing (CN)

(72) Inventors: Enxing HOU, Beijing (CN); Deguo MENG, Beijing (CN); Lijun HEI, Beijing (CN)

(73) Assignee: Xiaomi Inc.

(21) Appl. No.: 15/180,419

(22) Filed: Jun. 13, 2016

(30) Foreign Application Priority Data
Aug. 13, 2015 (CN) 201510497278.9

(51) Int. Cl. G05B 19/042; H04L 12/28

(52) U.S. Cl. CPC G05B 19/042; H04L 12/2816; G05B 2219/2642

(57) ABSTRACT

Disclosed includes a method for controlling an appliance. The method is performed by the appliance and comprises: receiving a radio broadcast message containing a first identifier; determining whether the first identifier matches a second identifier, the second identifier being a unique identifier associated with a wearable device and received from a mobile device that is in a binding relationship with, or communicatively coupled with, the wearable device; and after determining that the first identifier matches the second identifier, executing a preset operation command to switch from a first operation state to a second operation state. With embodiments of the present disclosure, a user can operate, remotely, an appliance to perform a certain task when the user is nearby. With such an arrangement, the appliance can complete the task by the time the user reaches the appliance, thereby improving the user's experience and operation efficiency.

### CROSS-REFERENCE TO RELATED APPLICATIONS

This application is based upon and claims priority to Chinese Patent Application No. 201510497278.9, filed on Aug. 13, 2015, which is incorporated herein by reference in its entirety.

### TECHNICAL FIELD

The present disclosure is related to the field of appliances, and more particularly, to methods and apparatuses for operating smart appliances.

### BACKGROUND

Under current technologies, there are various smart appliances such as, for example, smart air-conditioners, smart water dispensers, smart refrigerators, etc. These smart appliances typically have network connectivity and can receive operation instructions from a network, so that users can remotely control operations of these smart appliances using a smart phone, a client terminal installed on a PC, etc.

However, a user typically needs to input operation commands at an interface of the smart phone (e.g., keyboard, touch screen, buttons, etc.), or the like, to control an operation of the smart appliances.

### SUMMARY

The embodiments of the present disclosure provide methods for controlling an appliance, and apparatuses thereof.

On one hand, a method for controlling an appliance is provided. The method is performed by the appliance, and comprises:

receiving a radio broadcast message containing a first identifier;

determining whether the first identifier matches a second identifier, the second identifier being a unique identifier associated with a wearable device and received from a mobile device that is in a binding relationship with, or communicatively coupled with, the wearable device; and

after determining that the first identifier matches the second identifier, executing a preset operation command to switch from a first operation state to a second operation state.

On the other hand, another method for operating an appliance is provided. The method is performed by a mobile device, and comprises:

acquiring one or more unique identifiers of one or more wearable devices, wherein the one or more wearable devices include at least one of: a first wearable device that is in a binding relationship with the mobile device, and a second wearable device communicatively coupled with the mobile device; and

transmitting at least one of the one or more unique identifiers to an appliance to cause the appliance to store the at least one of the one or more unique identifiers, and to execute a preset operation command after receiving a radio broadcast message containing the at least one of the one or more unique identifiers.

Also, yet another method for operating an appliance is provided. The method being performed by a wearable device, and comprises:

transmitting, periodically to an appliance, a radio broadcast message containing a unique identifier of the wearable device;

wherein the radio broadcast message causes the appliance to execute a preset operation command if the unique identifier contained in the radio broadcast message matches with a stored identifier at the appliance.

Moreover, an appliance is provided. The appliance comprises a processor; and a memory storing an instruction executable by the processor; wherein the processor is configured to:

receive a radio broadcast message containing a first identifier;

determine whether the first identifier matches a second identifier, the second identifier being a unique identifier associated with a wearable device and received from a mobile device that is in a binding relationship with or communicatively coupled with the wearable device; and

after determining that the first identifier matches the second identifier, execute a preset operation command to switch from a first operation state to a second operation state.

Furthermore, a mobile device is provided. The mobile device comprises a processor; and a memory storing an instruction executable by the processor, wherein the processor is configured to:

acquire one or more unique identifiers of one or more wearable devices, wherein the one or more wearable devices includes at least one of: a first wearable device that is in a binding relationship with the mobile device, and a second wearable device communicatively coupled with the mobile device; and

transmit at least one of the one or more unique identifiers to an appliance to cause the appliance to store the at least one of the one or more unique identifiers, and to execute a preset operation command after receiving a radio broadcast message containing the at least one of the one or more unique identifiers.

Moreover, a wearable device is provided. The wearable device comprises a processor; and a memory storing an instruction executable by the processor, wherein the processor is configured to:

transmit, periodically to an appliance, a radio broadcast message containing a unique identifier of the wearable device;

wherein the radio broadcast message causes the appliance to execute a preset operation command if the unique identifier contained in the radio broadcast message matches with a stored identifier at the appliance.

With embodiments of the present disclosure, a user can operate, remotely, an appliance to perform a certain task when the user is nearby. With such an arrangement, the appliance can complete the task by the time the user reaches the appliance, thereby improving the user's experience and operation efficiency.

It should be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIGS. 1A-1B are block diagrams illustrating systems for operating smart appliances in the related arts.

FIG. 2 is a flow chart illustrating a method for operating a smart appliance, according to an exemplary embodiment.

FIGS. 3A-3B are schematic diagrams illustrating an interface for operating a wearable device, according to an exemplary embodiment.

FIG. 4 is a flow chart illustrating a method for operating a smart appliance, according to an exemplary embodiment.

FIG. 5 is a flow chart illustrating a method for operating a smart appliance, according to an exemplary embodiment.

FIG. 6 is a flow chart illustrating a method for operating a smart appliance, according to an exemplary embodiment.

FIG. 7 is a flow chart illustrating a method for processing a radio broadcast message, according to an exemplary embodiment.

FIGS. 8-9 are block diagrams illustrating apparatuses for operating a smart appliance, according to an exemplary embodiment.

FIG. 10 is a block diagram illustrating submodules of the exemplary apparatuses of FIGS. 8-9, according to an exemplary embodiment.

FIGS. 11-17 are block diagrams illustrating apparatuses for operating a smart appliance, according to an exemplary embodiment.

FIG. 18 is a block diagram illustrating an apparatus on which embodiments of the present disclosure can be implemented.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise presented. The embodiments set forth in the following description of exemplary embodiments do not represent all embodiments consistent with the invention. Instead, they are merely examples of apparatuses and methods consistent with aspects related to the invention as recited in the appended claims.

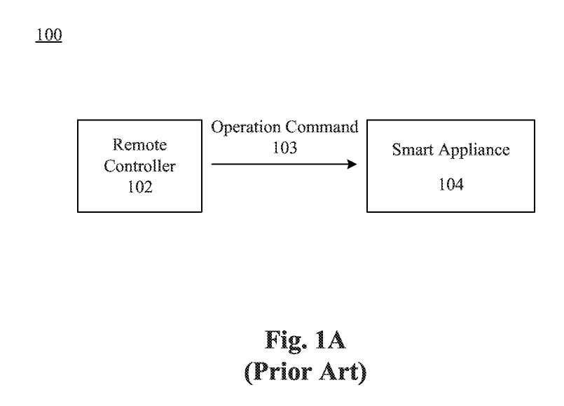

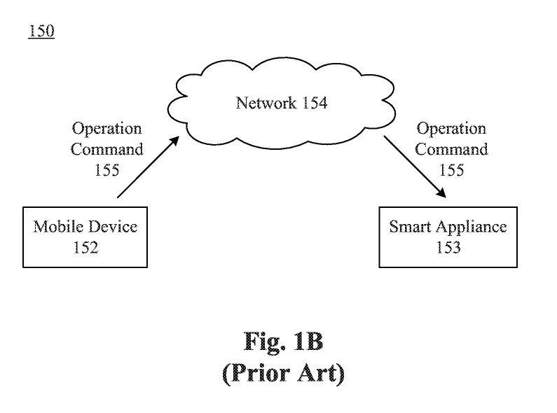

FIG. 1A illustrates a system 100 for operating smart appliances in the related arts. As shown in FIG. 1A, a remote controller 102, after detecting a user operation (e.g., a pressing action on a physical button), can transmit an operation command 103 to a smart appliance 104. Usually, the operation command 103 can be transmitted as infrared signals.

However, since different infrared encoding schemes are adopted for different smart appliances, using the scheme of FIG. 1A, each of the different smart appliances needs to be operated by a different remote controller. When multiple smart appliances are to be operated, multiple remote controllers will be required. As a result, there can be confusion about which remote controller to use, and the remote controllers can be difficult to locate.

FIG. 1B illustrates a system 150 which provides an attempt to solve the problems posed by system 100 of FIG. 1A. As shown in FIG. 1B, system 150 comprises a mobile device 152 and a smart appliance 153 connected via a network 154, such as a local area network (LAN) or the Internet. The mobile device 152 may transmit an operation command 155 targeted at the smart appliance 153 to the LAN or the Internet, which can then forward the operation command 155 to the smart appliance 153. The user can select a smart appliance to operate using the mobile device 152, which allows multiple smart appliances to be controlled.

Although the system 150 does not require multiple remote controllers, the user still needs to select a smart appliance for operation on an interface of the mobile device, and to input an operation command on the interface. Therefore, the inputting of the selection and operation commands are inefficient, which further increase the time it takes for the smart appliance to respond to the selection and the operation commands, which can lead to poor user experience.

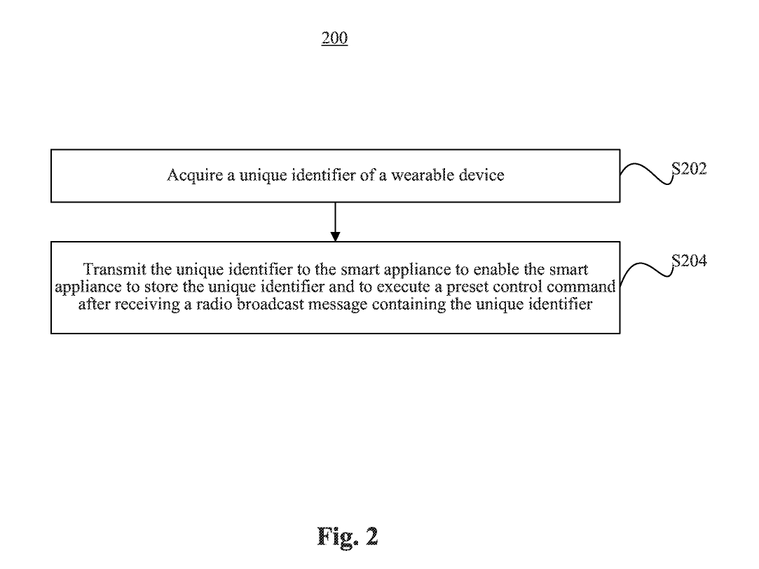

FIG. 2 is a flow chart illustrating a method 200 for operating a smart appliance, according to an exemplary embodiment. The method 200 can be performed by a mobile device (e.g., a smart phone). As shown in FIG. 2, the method 200 may comprise the following steps S202 and S204.

In step S202: the mobile device acquires a unique identifier of a wearable device.

According to embodiments of the present disclosure, in one case, a binding relationship can exist between the wearable device and the mobile device, such that the wearable device can confirm that the mobile device is a trusted device, and vice versa. Based on the confirmation, the mobile device acquires a unique identifier of the wearable device. In another case, the wearable device can be a device that is within a certain range of the mobile device and can communicate with the mobile device using near field communication (NFC). In this case, a binding relationship may or may not be established between the mobile device and the wearable device.

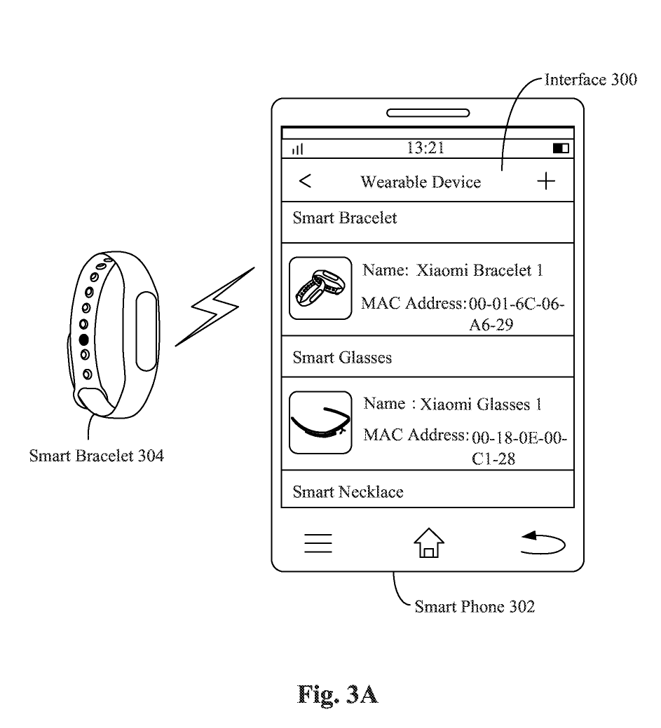

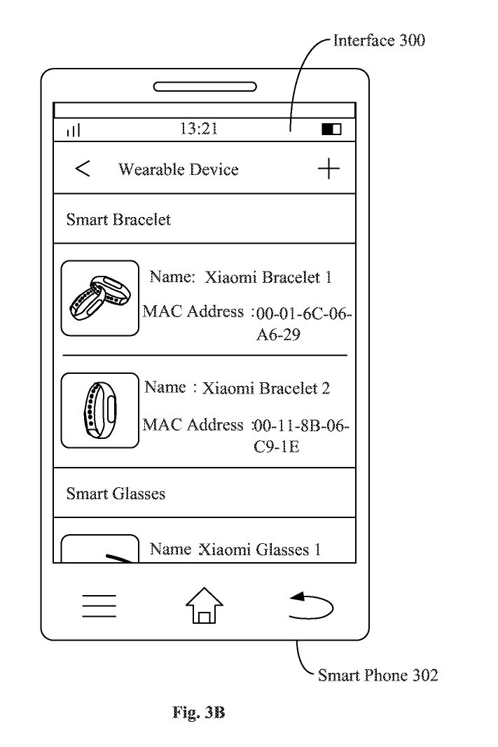

Reference is now made to FIGS. 3A and 3B, which illustrate an interface 300 for operating a wearable device, according to an exemplary embodiment. In FIG. 3A, a smart phone 302 can perform the method 200 of FIG. 2 and communicate with a wearable device, such as a smart bracelet 304. As shown in FIG. 3A, the interface 300 can display information about one or more wearable devices that have a binding relationship with the smart phone 302. The information includes a predetermined name of the wearable devices (e.g., “Xiaomi Bracelet 1”, “Xiaomi Glasses 1”, etc.). It is understood that the smart phone 302 can have a binding relationship with any types of wearable devices, such as smart bracelet, smart glasses, smart necklace, etc., and is not limited to the types of wearable devices described in this disclosure. Similarly, although the smart phone 302 is shown in FIG. 3A, it is understood that any other kinds of mobile devices, such as a tablet device, may also perform the method 200 and provide the interface 300.

Each wearable device is associated with a unique identifier, such that each wearable device is associated with a different identifier. As shown in FIG. 3A, the unique identifier can be a media access control (MAC) address of a wearable device. For example, the MAC address of the smart bracelet named “Xiaomi Bracelet 1” is “00-01-6C-06-A6-29”. The MAC address of the smart glasses named “Xiaomi Glasses 1” is “00-18-0E-00-C1-28”. Since a MAC address is physically bound to a wearable device, it can uniquely correspond to the wearable device. It is understood that MAC address is just one possible unique identifier, and other types of identifiers configured to uniquely correspond to a device can also be used in embodiments of the present disclosure. Such identifier can include, for example, a name identifier, a device number, a user's login account name, etc.

In some embodiments, the Bluetooth searching function of the smart handset 302 can be activated after an input on the interface 300 (e.g., a clicking action over the icon “+”) is detected. When the Bluetooth function of the smart bracelet 304 is activated, the smart bracelet 304 can be detected by the smart handset 302. As shown in FIG. 3B, the interface 300 can display information related to the wearable devices detected by the smart handset 304, such as the information related to the smart bracelet 304. For example, the smart bracelet 304 is named as “Xiaomi Bracelet 2”, and its corresponding MAC address is “00-11-8B-06-C9-1E”. Based on the information, the MAC address “00-11-8B-06-C9-1E” can uniquely correspond to the “Xiaomi Bracelet 2”.

Returning back to FIG. 2, the method 200 further includes step S204, in which the mobile device transmits the unique identifier to a smart appliance, to enable the smart appliance to store the unique identifier, and to execute a preset operation command after receiving a radio broadcast message containing the unique identifier. In some embodiments, the mobile device can communicate with the smart appliance through a local area network (LAN), or through the Internet.

In this embodiment, the mobile device may be continuously connected with the smart appliance. The mobile device may also be connected with the smart appliance only to transmit the unique identifier to the smart appliance; after the transmission of the unique identifier, the connection is terminated.

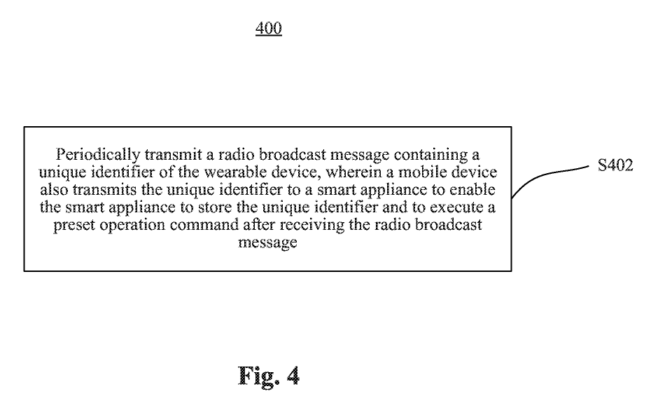

FIG. 4 is a flow chart illustrating a method 400 for operating a smart appliance, according to an exemplary embodiment. In some embodiments, the method 400 can be performed by a wearable device. As shown in FIG. 4, the method 400 comprises step S402.

In step S402, the wearable device periodically transmits a radio broadcast message containing a unique identifier of the wearable device. The wearable device may have a binding relationship with a mobile device, or may be within a certain range of the mobile device and communicate with the mobile device using near field communication (NFC). Each wearable device corresponds to one unique identifier. Moreover, the mobile device also communicates with a smart appliance through a local area network (LAN), or through the Internet. The mobile device can transmit the unique identifier to the smart appliance, to enable the smart appliance to store the unique identifier, and to execute a preset operation command when the smart appliance receives the radio broadcast message containing the unique identifier from the wearable device.

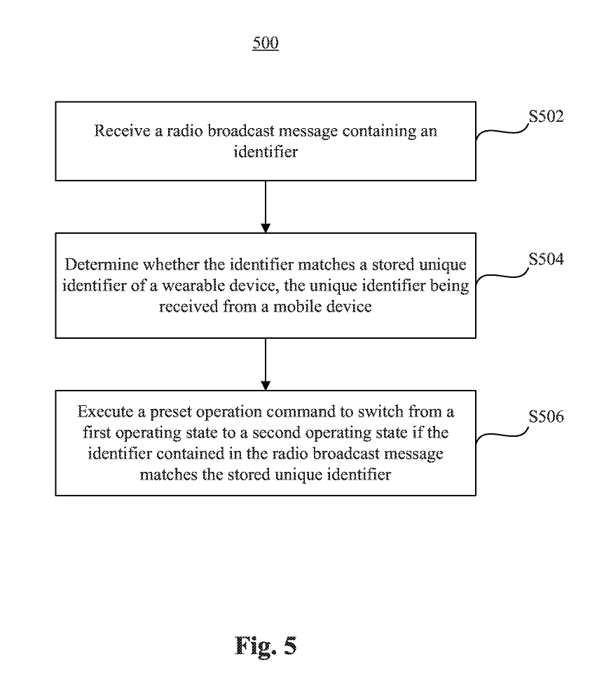

FIG. 5 is a flow chart illustrating a method 500 for operating a smart appliance, according to an exemplary embodiment. In some embodiments, the method 500 can be performed by a smart appliance. As shown in FIG. 5, the method 500 may comprise steps S502-S506.

In step S502, the smart appliance receives a radio broadcast message containing an identifier.

In step S504, the smart appliance determines whether the identifier in the radio broadcast message matches a stored unique identifier of a wearable device, the unique identifier being received from a mobile device that is either in a binding relationship with the wearable device, or is communicatively coupled with the wearable device through near field communication (NFC), and the unique identifier corresponds to the wearable device.

In step S506, after determining that the identifier in the radio broadcast message matches the stored unique identifier of a wearable device, the smart appliance executes an operation command to switch from a first operating state to a second operating state.

In this embodiment, the first operating state includes a state in which the smart appliance operates before executing the preset operation command, and the second operating state includes a state in which the smart appliance enters after automatically executing the preset operation command. According to embodiments of the present disclosure, the smart appliance can automatically switch between the two states.

According to embodiments of the present disclosure, by transmitting a unique identifier of a wearable device to the smart appliance, the smart appliance can identify the wearable device and then automatically execute a preset operation command. As a result, the operation of the smart appliance can be simplified, and user experience can be improved. In a case where the wearable device is in a binding relationship with the mobile device, the wearable device becomes a trusted device of the smart appliance, and vice versa, the security of the operation of the smart appliance can also be improved. In addition, embodiments of the present disclosure allow a user to operate, remotely, a smart appliance to perform a certain task (e.g., to start the operation of a smart air-conditioner, a smart TV, etc.) when the user is nearby (e.g., the smart appliance is within the radio transmission range of the wearable device the user is wearing). With such an arrangement, the smart appliance can complete the task (e.g., the smart air-conditioner sets the temperature to a certain degree, the smart TV is displaying the content of a preset channel, etc.) by the time the user reaches the smart appliance, thereby improving the user's experience and operation efficiency.

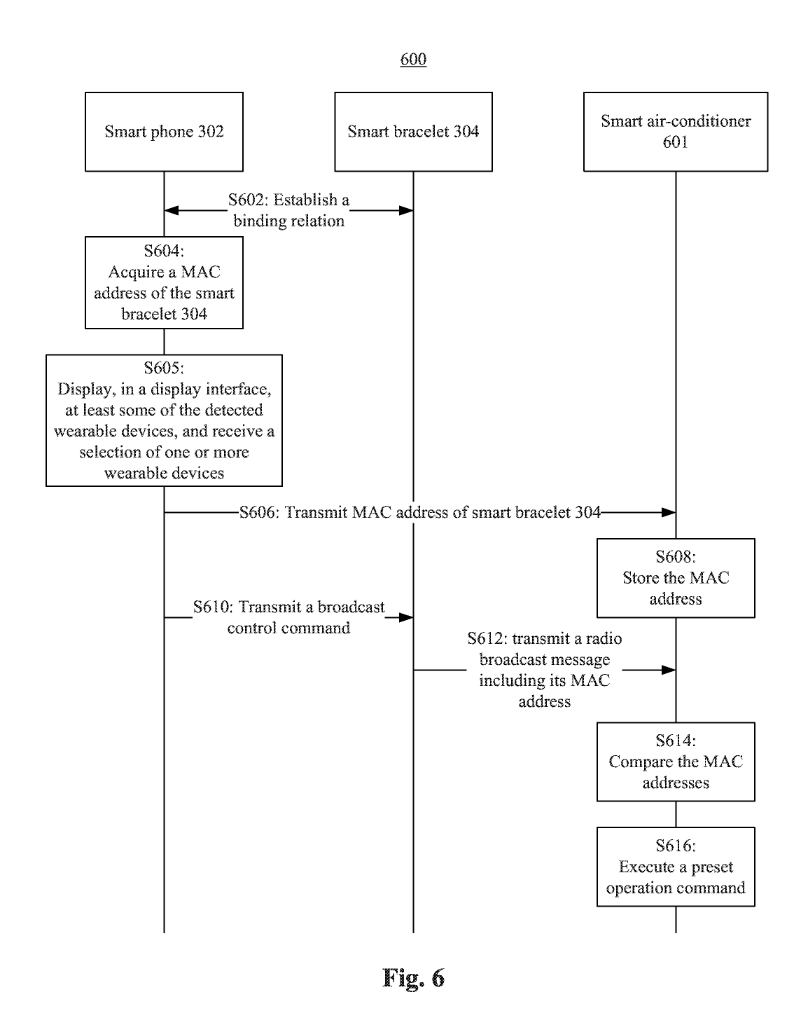

FIG. 6 is a flow chart illustrating a method 600 for operating a smart appliance, according to an exemplary embodiment. In some embodiments, the method 600 can be performed by a mobile device (e.g., the smart phone 302 of FIG. 3), a wearable device (e.g., the smart bracelet 304 of FIG. 3), and a smart appliance (e.g., a smart air-conditioner 601). As shown in FIG. 6, method 600 may comprise the following steps S602 to S616.

In step S602, the smart phone 302 and the smart bracelet 304 establish a binding relationship between them. The details of the binding relationship have been described before (e.g., with respect to FIGS. 3A-3B) and are not repeated here.

In step S604, the smart phone 302 acquires a MAC address of the smart bracelet 304. The smart phone 302 can use the MAC address as a unique identifier of the smart bracelet 304. Although FIG. 6 illustrates that the acquisition of the MAC address occurs after the binding relationship has been established, it is understood that the acquisition of the MAC address can also occur when the smart phone 302 detects the smart bracelet 304, with or without the binding relationship established.

In step S605: the smart phone 302 displays, in a display interface, at least some of the detected wearable devices, and receives a selection of one or more of the detected wearable devices (e.g., the smart bracelet 304).

In step S606: the smart phone 302 transmits the MAC address of the selected wearable device (e.g., the smart bracelet 304) to the smart air-conditioner 601.

In this embodiment, the smart phone 302 and the smart air-conditioner 601 may be connected to the same wireless LAN, and the MAC address may be transmitted using WiFi signals. It is understood that the data transmission between the smart phone 302 and the smart air-conditioner 601 may take any form, and is not limited to what has been described in the present disclosure.

In step S608, the smart air-conditioner 601 stores the received MAC address.

In step S610: the smart phone 302 transmits a broadcast control command to the smart bracelet 304.

In this embodiment, the smart phone 302 may include different information in the broadcast control command. For example, if the smart bracelet 304 is to be used to control an operation of the smart air-conditioner 601, the smart handset 302 may include first information in the broadcast control command to cause the smart bracelet 304 to periodically transmit a radio broadcast message containing its MAC address. On the other hand, if the controlling of the operation is to be terminated, the smart handset 302 may include second information in the broadcast control command to cause the smart bracelet 304 to terminate transmission of the radio broadcast message containing its MAC address. It is also understood that the smart phone 302 can control an operation of the smart bracelet 304 using other control schemes, and is not limited to the transmission of broadcast control command.

In step S612: in a case where the broadcast control command contains the first information, the smart bracelet 304 periodically transmits a radio broadcast message containing a MAC address of the smart bracelet.

With embodiments of the present disclosure, a smart bracelet (e.g., smart bracket 304) is configured with a sensor for receiving various preset parameters. The smart bracelet can be programmed with those parameters to start or terminate a periodic transmission of the radio broadcast message. As an illustrative example, in a case where the smart bracelet 304 detects a “clicking” operation, after detecting one or more “clicking” operations conforming to a first preset number of times/frequency/strength, the smart bracelet 304 can periodically transmit the radiobroadcast message. On the other hand, after detecting one or more “clicking” operations conforming to a second preset number of times/frequency/strength, the smart bracelet 304 can terminate the transmission of the radio broadcast message. In some cases, the “first preset number of times/frequency/strength” may be identical to the “second preset number of times/frequency/strength”. For example, each time the smart bracelet 304 detects one or more “clicking” operations, the smart bracket 304 may switch its operating modes (e.g., between a mode of a transmission of the radio broadcast message, and a mode of termination of the transmission of the radio broadcast message).

In some embodiments, the transmission of the radio broadcast message can also be controlled in other manners. For example, a mobile device (e.g., the smart phone 302) can transmit a broadcast control command to cause a smart bracelet (e.g., the smart bracelet 304) to transmit the radio broadcast message, and then the smart bracelet can terminate the transmission of the radio broadcast message after detecting one or more “clicking” operations.

It is understood that the above “clicking” operation is just an illustrative example. The smart bracelet 304 may detect other operations such as, for example, drawing a ring in the air with the bracelet, swinging the bracelet vertically or horizontally or the like, and can be controlled to transmit periodically (or to terminate a periodic transmission of) radio broadcast messages after detecting such operations. The types of operations detectable by the smart bracelet 304 for controlling the transmission of radio broadcast messages are not limited to those described in the present disclosure.

In step S614, the smart air-conditioner 601 compares the MAC address in the received radio broadcast message against the stored MAC address.

In this embodiment, the transmission of the radio broadcast message between the smart bracelet 304 and the smart air-conditioner 601 can be performed in any manner. For example, both the smart bracelet 304 and the smart air-conditioner 601 can support Bluetooth functions, and the radio broadcast message can be transmitted using Bluetooth signals.

In step S616, the smart air-conditioner 601 executes a preset operation command.

In this embodiment, the smart air-conditioner 601 can receive the radio broadcast message from the smart bracelet 304 when the smart air-conditioner 601 is within a certain radio transmission range of the smart bracelet 304 (as well as the user who wears the smart bracelet 304). With embodiments of the present disclosure, the user can operate, remotely, a smart appliance to perform a certain task (e.g., to start the operation of a smart air-conditioner, a smart TV, etc.) when the user is nearby (e.g., the smart appliance is within the radio transmission range of the wearable device the user is wearing). With such an arrangement, the smart appliance can complete the task (e.g., the smart air-conditioner sets the temperature to a certain degree, the smart TV is displaying the content of a preset channel, etc.) by the time the user reaches the smart appliance, thereby improving the user's experience and operation efficiency.

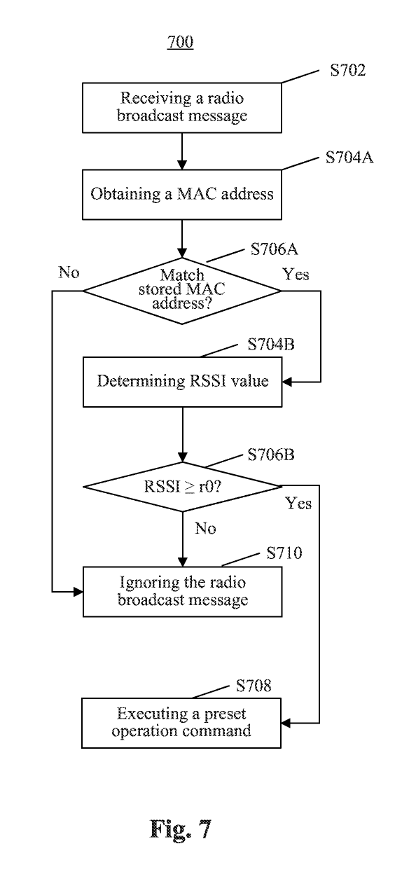

FIG. 7 is a flow chart illustrating a method 700 for processing a radio broadcast message, according to an exemplary embodiment. In some embodiments, the method 700 can be performed by a smart appliance (e.g., the smart air-conditioner 601 of FIG. 6). As shown in FIG. 7, the method 700 may comprise the following steps S702-S710:

In step S702: the smart appliance receives a radio broadcast message.

In step S704A: the smart appliance obtains an MAC address from the radio broadcast message.

In step S706A, the smart appliance compares the obtained MAC address against a stored MAC address. If they do not match, the smart appliance proceeds to step S710 and ignore the broadcast message.

In this embodiment, the smart appliance can receive the stored MAC address from a mobile device. The mobile device receives a MAC address from a wearable device, and transmits the MAC address to the smart appliance for storage. In a case where a binding relationship has been established between the mobile device and the wearable device, the mobile device and wearable device can become trusted devices, and the security of operation of the smart appliance can be improved.

If in step S706A the smart appliance determines that the obtained MAC address matches the stored MAC address, the smart appliance can proceed to step S704B, in which the smart appliance determines a value of a received signal strength indication (RSSI) of the radio broadcast message.

In step S706B, the smart appliance determines whether the RSSI value equals or exceeds a preset signal strength threshold r0. If the smart appliance determines that the RSSI value is less than r0, the smart appliance proceeds to step S710 and ignore the broadcast message.

On the other hand, if the RSSI value equals or exceeds the preset signal strength threshold r0 (determined in step S706B) and that the obtained MAC from the radio broadcast message matches the stored MAC address (determined in step S706A), the smart appliance can proceed to step S708 and execute a preset operation command, to switch from a first operating state to a second operating state.

In this embodiment, the RSSI value can be related to a measurement of a physical distance between the wearable device (and the user who wears the wearable device) and the smart appliance. For example, the RSSI value can be inversely proportional to the physical distance. In other words, the greater the RSSI value is, the smaller the distance is, and vice versa.

In this embodiment, the preset operation command is configured to adjust at least one of an operation parameter and an operation mode of the smart appliance. In the following illustrative example, a description of an adjustment process for the operation parameter and operation mode of a smart air-conditioner (e.g., smart air-conditioner 601) will be provided. It is understood that the preset operation command according to embodiments of the present disclosure can be used to adjust at least one of an operation parameter and an operation mode of any other smart appliances, and not just limited to smart air-conditioner. Moreover, the operation parameters and the operation modes are also provided as non-limiting examples for illustrative purpose, and do not limit the scope of the present disclosure.

The operating parameters of a smart air-conditioner 601 may comprise at least one of: an operation frequency, an air guiding angle, etc. The smart air-conditioner can adjust at least one of the operation frequency and the air guiding angle in response to an execution of a preset operation command (e.g., in step S708).

For example, the smart air-conditioner 601 may operate under a relatively low frequency at the beginning. After detecting that the user is close by (e.g., based on the determination results in steps S706A and S706B), the smart air-conditioner 601 can increase the operation frequency to, for example, speed up the cooling or heating effect. As a result, user experience can be enhanced. The operating frequency may be adjusted according to the distance from the user based on a reverse correlation. For example, the smaller the distance is, the higher the operating frequency can become, and vice versa.

Moreover, the smart air-conditioner 601 may also adjust the air guiding angle based on information about the user distance. For example, when the smart air-conditioner 601 detects that the user is close by, the smart air-conditioner 601 may adjust the air guiding angle to cause the discharged wind to flow towards the user, to improve the cooling or heating effect. As a result, user experience can be enhanced. The smart air-conditioner may calculate an air guiding angle based on the detected RSSI value, as well as information about an installation height of the smart air-conditioner.

In some embodiments, the smart air-conditioner 601 can also determine that the user is nearby, based on the received MAC address (and the transmission range for the radio broadcast message that includes the MAC address), and set the air guiding angle accordingly. For example, in a case where the air-conditioner is located in a living room, the smart air-conditioner can set a certain air guiding angle to blow wind towards a sofa in the living room, after detecting that the user is nearby based on the received MAC address (e.g., according to the determination result in step 706A).

In some embodiments, the smart air-conditioner 601 can have various operating modes, such as a sleeping mode, a humidity-removing mode, a ventilating mode, and a powerful mode etc. For example, the smart air-conditioner 601 may switch from a sleeping mode at the beginning. When the smart air-conditioner 601 detects that the user is nearby (e.g., based on the reception of MAC address, and/or RSSI value), the smart air-conditioner 601 may switch to the powerful mode to increase its operating frequency, as well as its temperature adjustment power, to enhance the user experience.

Further, when the smart air-conditioner 601 determines that a radio broadcast message is not received in a preset time period, which may indicate that the user is relatively far away from the smart appliance (for example, the user has left the room where the smart appliance is installed), the smart air-conditioner 601 may switch back to the first operation state. For example, the smart air-conditioner 601 may reduce its operating frequency to save power.

Using embodiments of the present disclosure, multiple smart appliances can also be operated based on a location of the wearable device (and the location of the user who wears the wearable device). As an illustrative example, a plurality of smart air-conditioners can be installed in, for example, a living room and a bedroom of a house. When a user enters the house and passes the door (or is about to pass the door) that leads to the living room, the smart air-conditioner in the living room can receive a radio broadcast message transmitted by a wearable device worn by the user, when the wearable device is within the radio transmission range of the smart air-conditioner. Then, the smart air-conditioner in the living room can automatically adjust its operating frequency and air guiding angle and other operating parameters, and/or switches its operating mode from the sleeping mode to the powerful mode, to speed up the setting of a particular temperature in the living room, before the user enters the living room.

Also, when the user walks towards the bedroom from the living room, before the user enters the bedroom, the smart air-conditioner in the bedroom can also receive a radio broadcast message transmitted by the wearable device, when the wearable device is within the radio transmission range of the smart air-conditioner. Then, the smart air-conditioner in the bedroom can automatically adjust its operating frequency and air guiding angle and other operating parameters, or switch its operating mode from the sleeping mode to the powerful mode, to speed up the setting of a particular temperature in the bedroom before the user enters the bedroom. At the same time, after the user leaves the living room, the smart air-conditioner in the living room may determine that it does not receive another radio broadcast message (which it expects to receive periodically from the wearable device) in a preset time period. Based on this determination, the smart air-conditioner in the living room can return to its original operating state (e.g., back to sleeping mode) to save power.

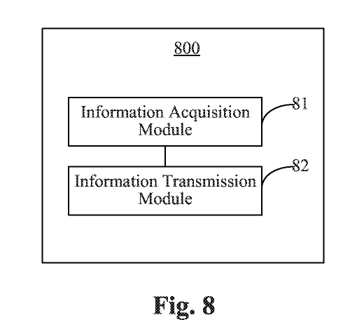

FIG. 8 is a block diagram illustrating an apparatus 800 for operating a smart appliance, according to an exemplary embodiment. In some embodiments, the apparatus 800 can be part of a mobile device (e.g., the smart phone 302) that can communicate with a smart appliance (e.g., the smart air-conditioner 601) and with a wearable device (e.g., the smart bracelet 304). The mobile device may communicate with the smart appliance through a local area network (LAN), or through the Internet.

As shown in FIG. 8, the apparatus 800 comprises an information acquisition module 81 and an information transmission module 82.

The information acquisition unit 81 is configured to acquire a unique identifier of at least one wearable device (e.g., the smart bracelet 304). The wearable device can be in a binding relationship with the mobile device, or can be within a certain range of the mobile device, and can communicate with the mobile device through near field communication (NFC) in a certain range. The wearable device also corresponds to one unique identifier.

The information transmission module 82 is configured to transmit the unique identifier to the smart appliance (e.g., the smart air-conditioner 601), to enable the smart appliance to store the unique identifier, and to execute a preset operation command when the smart appliance receives a radio broadcast message containing the unique identifier.

In some embodiments, the unique identifier includes a MAC address.

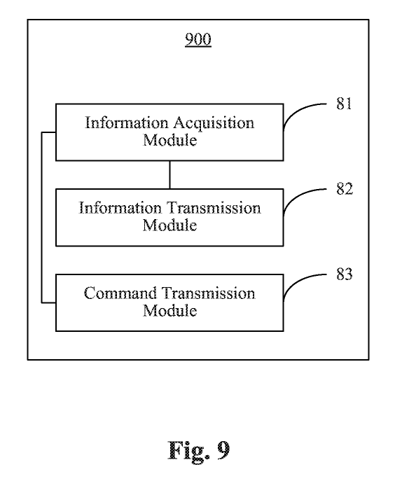

FIG. 9 is a block diagram illustrating an apparatus 900 for operating a smart appliance, according to an exemplary embodiment. In some embodiments, the apparatus 900 can be part of a mobile device (e.g., the smart phone 302) that can communicate with a smart appliance (e.g., the smart air-conditioner 601) and with a wearable device (e.g., the smart bracelet 304). As shown in FIG. 9, the apparatus 900 comprises the information acquisition module 81 and the information transmission module 82 of FIG. 8. The apparatus 900 further comprises a command transmission module 83.

The command transmission module 83 is configured to transmit a broadcast control command to the wearable device after the information transmission module 82 transmits the unique identifier to the smart appliance. The broadcast control command is configured to control a mode of transmission of a broadcast message by the wearable device. For example, if the broadcast control command comprises first information, the wearable device can be controlled to periodically transmit a radio broadcast message containing the unique identifier. When the broadcast control command comprises second information, the wearable device can be controlled to terminate the periodic transmission of the radio broadcast message.

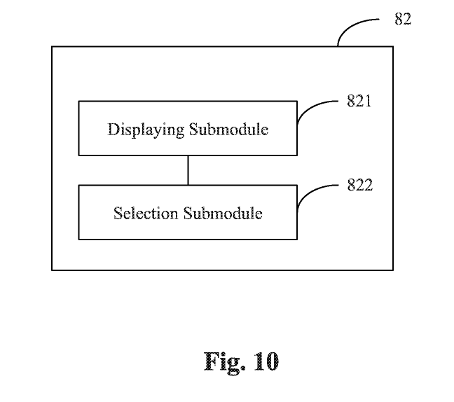

FIG. 10 is a block diagram illustrating the submodules of the information transmission module 82 of FIG. 8. As shown in FIG. 10, the information transmission module 82 comprises a displaying submodule 821 and a selection submodule 822.

The displaying submodule 821 is configured to provide data for displaying the at least one wearable device to a display interface.

The selection submodule 822 is configured to detect a selection command of one or more wearable device (e.g., at the display interface, or at any other interface), and transmit one or more unique identifiers that correspond to the one or more selected wearable devices to the smart appliance.

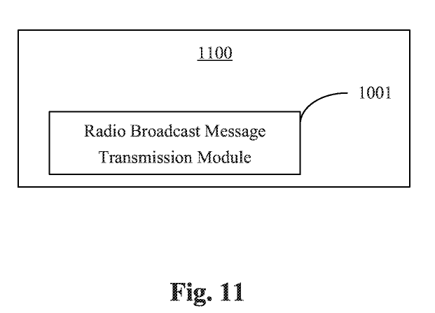

FIG. 11 is a block diagram illustrating an apparatus 1100 for operating a smart appliance, according to an exemplary embodiment. In some embodiments, the apparatus 1100 can be part of a wearable device (e.g., the smart bracelet 304) that can communicate with a mobile device (e.g., the smart phone 302) and a smart appliance (e.g., the smart air-conditioner 601). As shown in FIG. 11, the apparatus 1100 comprises a radio broadcast message transmission module 1001.

The radio broadcast message transmission module 1001 is configured to periodically transmit a radio broadcast message containing a unique identifier of the wearable device. The radio broadcast message can be received by the smart appliance, which can compare the unique identifier in the radio broadcast message against a stored unique identifier, which the smart appliance received from the mobile device. After determining that the two identifiers match, the smart appliance can execute a preset operation command.

In some embodiments, the unique identifier includes a MAC address.

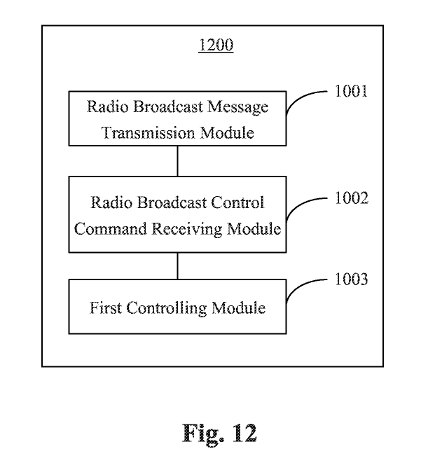

FIG. 12 is a block diagram illustrating an apparatus 1200 for operating a smart appliance, according to an exemplary embodiment. In some embodiments, apparatus 1200 can be part of a wearable device (e.g., the smart bracelet 304) that can communicate with a mobile device (e.g., the smart phone 302) and a smart appliance (e.g., the smart air-conditioner 601). As shown in FIG. 12, apparatus 1200 comprises the radio broadcast message transmission module 1001 of FIG. 11, a radio broadcast control command receiving module 1002, and a first controlling module 1003.

The radio broadcast control command receiving module 1002 is configured to receive a broadcast control command from the mobile device.

The first controlling module 1003 is configured to periodically transmit the radio broadcast message based on a determination that the broadcast control command comprises first information, and to terminate the periodic transmission of the radio broadcast message based on a determination that the broadcast control command comprises second information.

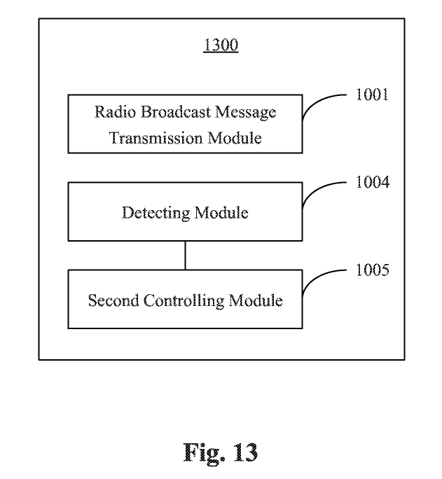

FIG. 13 is a block diagram illustrating an apparatus 1300 for operating a smart appliance, according to an exemplary embodiment. In some embodiments, the apparatus 1300 can be part of a wearable device (e.g., the smart bracelet 304) that can communicate with a mobile device (e.g., the smart phone 302) and a smart appliance (e.g., the smart air-conditioner 601). As shown in FIG. 13, the apparatus 1300 comprises the radio broadcast message transmission module 1001, a detecting module 1004, and a second controlling module 1005. In some embodiments, at least one of the detecting module 1004 and the second controlling module 1005 can also be included in the apparatus 1200 of FIG. 12.

The detecting module 1004 is configured to detect a user operation on the wearable device.

The second controlling module 1005 is configured to determine the user operation detected by the detecting module 1004. If the user operation is determined to be a first preset operation, the second controlling module 1005 can determine to transmit the radio broadcast message periodically. If the user operation is determined to be a second preset operation, the second controlling module 1005 can terminate the periodic transmission of the radio broadcast message.

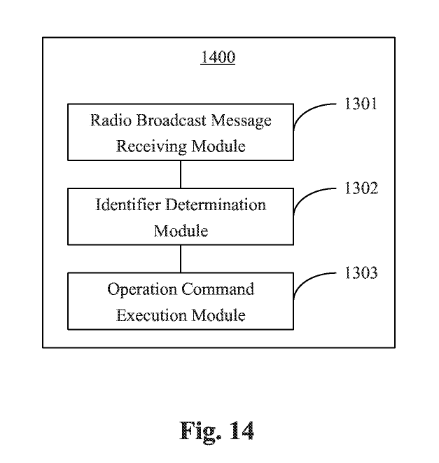

FIG. 14 is a block diagram illustrating an apparatus 1400 for operating a smart appliance, according to an exemplary embodiment. In some embodiments, the apparatus 1400 can be part of a smart appliance (e.g., the smart air-conditioner 601) that can communicate with a wearable device (e.g., the smart bracelet 304) and a mobile device (e.g., the smart phone 302). As shown in FIG. 14, the apparatus 1400 comprises a radio broadcast message receiving module 1301, an identifier determination module 1302, and an operation command execution module 1303.

The radio broadcast receiving module 1301 is configured to receive a radio broadcast message containing an identifier.

The identifier determination module 1302 is configured to determine whether the identifier from the radio broadcast message matches with a stored unique identifier of a wearable device, which the smart appliance receives from the mobile device. As discussed before, the mobile device can be in a binding relationship with the wearable device. The mobile device can also be within a certain range of the wearable device and can communicate with the mobile device through near field communication (NFC). The wearable device can correspond to one unique identifier.

The operation command execution module 1303 is configured to execute a preset operation command to switch from a first operation state to a second operation state, based on a determination, by identifier determination module 1302, that the identifier from the radio broadcast message matches with a stored unique identifier of a wearable device.

Optionally, the preset operation command is configured to adjust at least one of an operation parameter and an operation mode of the smart appliance which includes apparatus 1400.

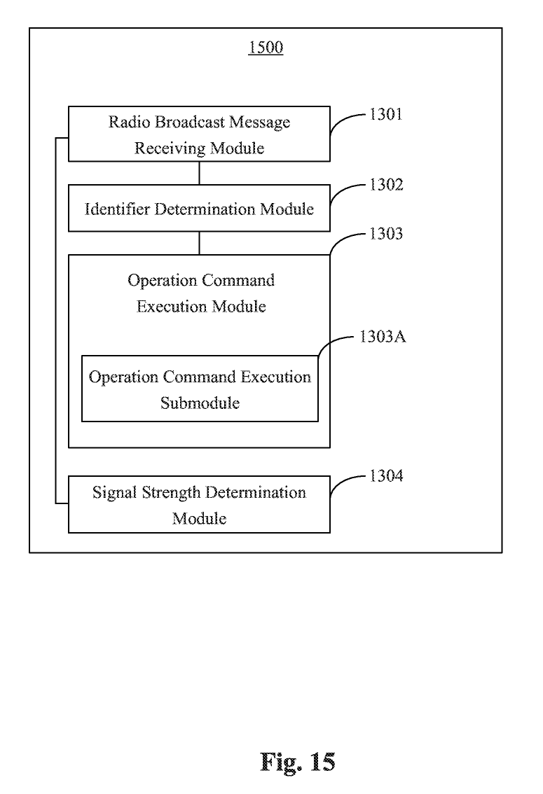

FIG. 15 is a block diagram illustrating an apparatus 1500 for operating a smart appliance, according to an exemplary embodiment. In some embodiments, the apparatus 1500 can be part of a smart appliance (e.g., the smart air-conditioner 601) that can communicate with a wearable device (e.g., the smart bracelet 304) and a mobile device (e.g., the smart phone 302). As shown in FIG. 15, the apparatus 1500 comprises the radio broadcast message receiving module 1301, the identifier determination module 1302, and the operation command execution module 1303 of FIG. 14. The operation command execution module 1303 may comprise an operation command execution submodule 1303A. In addition, the apparatus 1500 further comprises a signal strength determination module 1304.

The signal strength determination module 1304 is configured to determine a received signal strength indication (RSSI) value of the radio broadcast message received by the radio broadcast message receiving module 1301.

The operation command execution submodule 1303A is configured to execute the preset control command based on a determination (by the signal strength determination module 1304) that the received signal strength indication value equals to (or exceeds) a preset threshold value, and based on a determination (by the identifier determination module 1302) that the radio broadcast message contains the unique identifier.

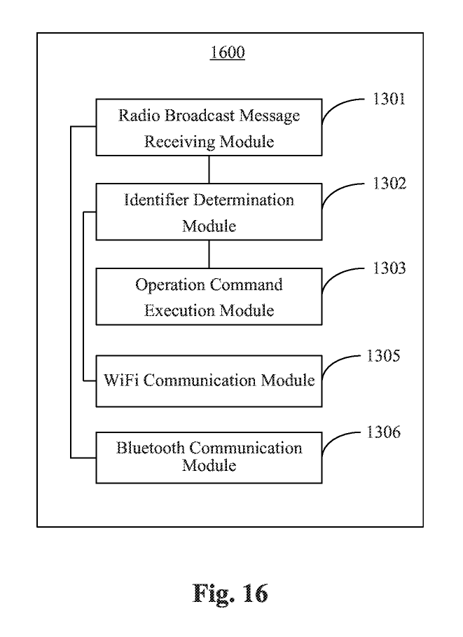

FIG. 16 is a block diagram illustrating an apparatus 1600 for operating a smart appliance, according to an exemplary embodiment. In some embodiments, the apparatus 1600 can be part of a smart appliance (e.g., the smart air-conditioner 601) that can communicate with a wearable device (e.g., the smart bracelet 304) and a mobile device (e.g., the smart phone 302). As shown in FIG. 16, the apparatus 1600 comprises the radio broadcast message receiving module 1301, the identifier determination module 1302, and the operation command execution module 1303 of FIG. 14. In addition, the apparatus 1600 further comprises a WiFi communication module 1305, and a Bluetooth communication module 1306. In some embodiments, at least one of the WiFi communication module 1305 and the Bluetooth communication module 1306 can be included in the apparatus 1500 of FIG. 15.

The WiFi communication module 1305 is configured to receive the unique identifier from the mobile device through a WiFi connection established therewith. The smart appliance can then store the unique identifier, and provide that to identifier determination module 1302 for comparison with an identifier obtained from a radio broadcast message.

The Bluetooth communicating unit 1306 is configured to receive the radio broadcast message through a Bluetooth connection established with the wearable device.

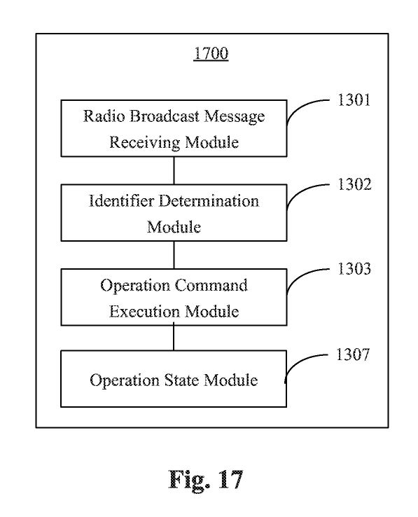

FIG. 17 is a block diagram illustrating an apparatus 1700 for operating a smart appliance, according to an exemplary embodiment. In some embodiments, the apparatus 1700 can be part of a smart appliance (e.g., the smart air-conditioner 601) that can communicate with a wearable device (e.g., the smart bracelet 304) and a mobile device (e.g., the smart phone 302). As shown in FIG. 17, the apparatus 1700 comprises the radio broadcast message receiving module 1301, the identifier determination module 1302, and the operation command execution module 1303 of FIG. 14. The apparatus 1700 also comprises an operation state module 1307. In some embodiments, the operation state module 1307 can be included in the apparatus 1500 of FIG. 15 and the apparatus 1600 of FIG. 16.

The operation state module 1307 is configured to switch an operation state of the smart appliance based on one or more criteria. For example, based on a determination that the radio broadcast message receiving module has not received a periodic radio broadcast message in a preset time period, the operation state module 1307 can change the operation state (e.g., to an operation state before the reception of a prior radio broadcast message).

With respect to the apparatus in the above embodiments, the specific manners for performing operations for individual modules therein have been described in detail in the embodiments regarding the related methods, which will not be elaborated herein.

Since the apparatus embodiments substantially correspond to the method embodiments, similar parts of the method embodiments may be referred to for the apparatus embodiments. The above apparatus embodiments are illustrative only. The units described as separate members may be or may not be physically separated. The members described as units may be or may not be physical units, may be located at the same place or may be distributed in multiple network units. The objectives of the solutions of this disclosure may be realized by selecting some or all of the modules according to the actual needs. The above can be understood and implemented by those skilled in the art without any inventive work.

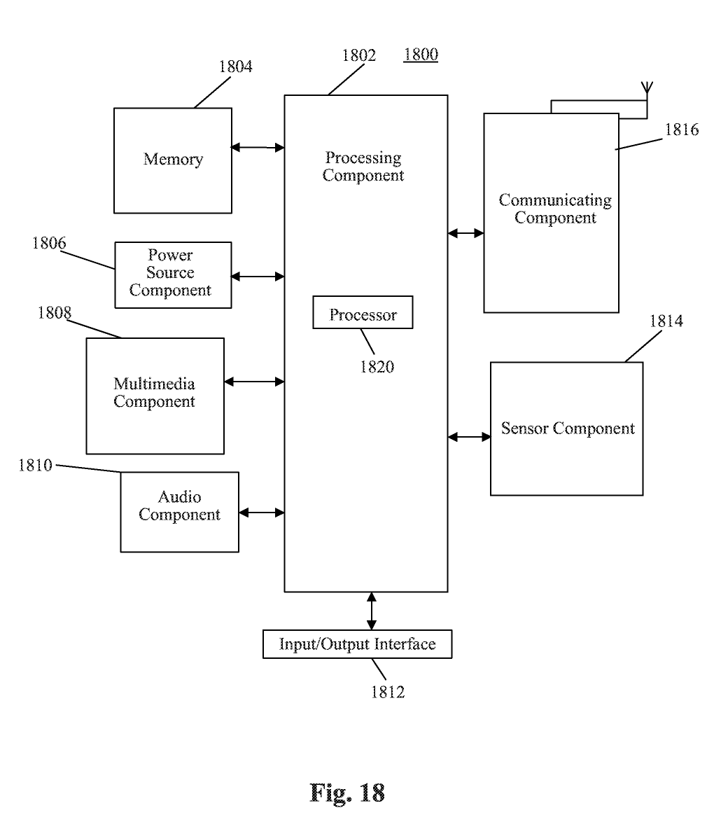

FIG. 18 is a block diagram illustrating an apparatus 1800 for controlling a smart appliance according to an exemplary embodiment. For example, when embodied as a mobile device, the apparatus 1800 may be a mobile phone, a computer, a digital broadcast terminal, a messaging device, a gaming console, a tablet, a medical device, exercise equipment, a personal digital assistant or the like; when embodied as a wearable device, the apparatus 1800 may be a smart bracelet, smart glasses, a smart necklace, a smart ring or the like; when embodied as a smart appliance, the apparatus 1800 may be a smart air-conditioner, a smart water dispenser, a smart refrigerator or the like.

Referring to FIG. 18, the apparatus 1800 may include one or more of the following components: a processing component 1802, a memory 1804, a power component 1806, a multimedia component 1808, an audio component 1810, an input/output (I/O) interface 1812, a sensor component 1814, and a communication component 1816.

The processing component 1802 typically controls overall operations of the apparatus 1800, such as the operations associated with display, telephone calls, data communications, camera operations, and recording operations. The processing component 1802 may include one or more processors 1820 to execute instructions to perform all or part of the steps in the above described methods. The instructions can also be organized as the modules (and submodules) in the above described apparatuses. Moreover, the processing component 1802 may include one or more modules (and sub-modules) which facilitate the interaction between the processing component 1802 and other components. For instance, the processing component 1802 may include a multimedia module to facilitate the interaction between the multimedia component 1808 and the processing component 1802.

The memory 1804 is configured to store various types of data to support the operation of the apparatus 1800. Examples of such data include instructions for any applications or methods operated on the apparatus 1800, contact data, phonebook data, messages, pictures, video, etc. The memory 1804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1806 provides power to various components of the apparatus 1800. The power component 1806 may include a power management system, one or more power sources, and any other components associated with the generation, management, and distribution of power in the apparatus 1800.

The multimedia component 1808 includes a screen providing an output interface between the apparatus 1800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1808 includes a front camera and/or a rear camera. The front camera and the rear camera may receive an external multimedia datum while the apparatus 1800 is in an operation mode, such as a photographing mode or a video mode. Each of the front camera and the rear camera may be a fixed optical lens system or have focus and optical zoom capability.

The audio component 1810 is configured to output and/or input audio signals. For example, the audio component 1810 includes a microphone (“MIC”) configured to receive an external audio signal when the apparatus 1800 is in an operation mode, such as a call mode, a recording mode, and a voice recognition mode. The received audio signal may be further stored in the memory 1804 or transmitted via the communication component 1816. In some embodiments, the audio component 1810 further includes a speaker to output audio signals.

The I/O interface 1812 provides an interface between the processing component 1802 and peripheral interface modules, such as a keyboard, a click wheel, buttons, and the like. The buttons may include, but are not limited to, a home button, a volume button, a starting button, and a locking button.

The sensor component 1814 includes one or more sensors to provide status assessments of various aspects of the apparatus 1800. For instance, the sensor component 1814 may detect an open/closed status of the apparatus 1800, relative positioning of components, e.g., the display and the keypad, of the apparatus 1800, a change in position of the apparatus 1800 or a component of the apparatus 1800, a presence or absence of user contact with the apparatus 1800, an orientation or an acceleration/deceleration of the apparatus 1800, and a change in temperature of the apparatus 1800. The sensor component 1814 may include a proximity sensor configured to detect the presence of nearby objects without any physical contact. The sensor component 1814 may also include a light sensor, such as a CMOS or CCD image sensor, for use in imaging applications. In some embodiments, the sensor component 1814 may also include an accelerometer sensor, a gyroscope sensor, a magnetic sensor, a pressure sensor, or a temperature sensor.

The communication component 1816 is configured to facilitate communication, wired or wirelessly, between the apparatus 1800 and other devices. The apparatus 1800 can access a wireless network based on a communication standard, such as WiFi, 2G, or 3G, or a combination thereof. In one exemplary embodiment, the communication component 1816 receives a broadcast signal or broadcast associated information from an external broadcast management system via a broadcast channel. In one exemplary embodiment, the communication component 1816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1804, executable by the processor 1820 in the apparatus 1800, for performing the above-described methods. For example, the non-transitory computer-readable storage medium may be a ROM, a RAM, a CD-ROM, a magnetic tape, a floppy disc, an optical data storage device, and the like. The non-transitory computer readable medium may store instructions that correspond to any of the modules and submodules of FIGS. 8-17. The instructions, when executed by processor 1820, may also cause processor 1820 to perform any of methods of FIGS. 1-7.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling an appliance, the method being performed by the appliance and comprising:
receiving a radio broadcast message containing a first identifier;
determining whether the first identifier matches a second identifier, the second identifier being a unique identifier associated with a wearable device and received from a mobile device that is in a binding relationship with, or communicatively coupled with, the wearable device; and
after determining that the first identifier matches the second identifier, executing a preset operation command to switch from a first operation state to a second operation state.

2. The method according to claim 1, further comprising:
determining a received signal strength indication value of the radio broadcast message;
wherein the preset operation command is executed based on a determination that the received signal strength indication value equals or exceeds a preset threshold, and a determination that the first identifier matches the second identifier.

3. The method according to claim 1, wherein the preset control command is configured to adjust at least one of an operation parameter and an operation mode of the appliance.

4. The method according to claim 1, further comprising:
receiving, from the mobile device, the second identifier through a WiFi connection established with the mobile device; and
receiving the radio broadcast message through a Bluetooth connection established with the wearable device.

5. The method according to claim 1, wherein the radio broadcast message is a first radio broadcast message, the method further comprising:
determining whether a second radio broadcast message is received in a preset time period; and
after determining that the second radio broadcast message is not received in a preset time period, switching from the second operation state to the first operation state.

6. A method for operating an appliance, the method being performed by a mobile device and comprising:
acquiring one or more unique identifiers of one or more wearable devices, wherein the one or more wearable devices include at least one of: a first wearable device that is in a binding relationship with the mobile device, and a second wearable device communicatively coupled with the mobile device; and
transmitting at least one of the one or more unique identifiers to an appliance to cause the appliance to store the at least one of the one or more unique identifiers, and to execute a preset operation command after receiving a radio broadcast message containing the at least one of the one or more unique identifiers.

7. The method according to claim 6, wherein the at least one of the one or more unique identifiers includes a MAC address.

8. The method according to claim 6, wherein transmitting at least one of the one or more unique identifiers to an appliance comprises:
providing data related to the one or more wearable devices for displaying;
receiving an indication related to a selection of at least one of the one or more wearable devices; and
transmitting a unique identifier of the selected at least one of the one or more wearable devices to the appliance.

9. The method according to claim 6, further comprising:
after transmitting the at least one of the one or more unique identifiers to the smart appliance, transmitting a broadcast control command to the wearable device;
wherein the broadcast control command comprises information configured to cause the wearable device to periodically transmit the radio broadcast message, or terminate the periodic transmission of the radio broadcast message.

10. A method for operating an appliance, the method being performed by a wearable device and comprising:
transmitting, periodically to an appliance, a radio broadcast message containing a unique identifier of the wearable device;
wherein the radio broadcast message causes the appliance to execute a preset operation command if the unique identifier contained in the radio broadcast message matches with a stored identifier at the appliance.

11. The method according to claim 10, wherein the unique identifier includes a MAC address.

12. The method according to claim 10, further comprising:
receiving a broadcast control command from a mobile device;
determining information contained in the broadcast control command;
transmitting the radio broadcast message periodically, if the information contained in the broadcast control command is determined to include first information; and
terminating a periodic transmission of the radio broadcast message, if the information contained in the broadcast control command is determined to include second information.

13. The method according to claim 10, further comprising:
determining a user operation on the wearable device;
transmitting the radio broadcast message periodically, if the user operation is determined to include a first preset operation; and
terminating a periodic transmission of the radio broadcast message, if the user operation is determined to include a second preset operation.

14. An appliance, comprising:
a processor; and
a memory storing an instruction executable by the processor;
wherein the processor is configured to:
receive a radio broadcast message containing a first identifier;
determine whether the first identifier matches a second identifier, the second identifier being a unique identifier associated with a wearable device and received from a mobile device that is in a binding relationship with or communicatively coupled with the wearable device; and
after determining that the first identifier matches the second identifier, execute a preset operation command to switch from a first operation state to a second operation state.

15. The appliance according to claim 14, wherein the processor is also configured to:
determine a received signal strength indication value of the radio broadcast message;
wherein the preset operation command is executed based on a determination that the received signal strength indication value equals or exceeds a preset threshold, and a determination that the first identifier matches the second identifier.

16. The appliance according to claim 14, wherein the preset control command is configured to adjust at least one of an operation parameter and an operation mode of the appliance.

17. The appliance according to claim 14, wherein the processor is also configured to:
receive, from the mobile device, the second identifier through a WiFi connection established with the mobile device; and
receive the radio broadcast message through a Bluetooth connection established with the wearable device.

18. The appliance according to claim 14, wherein the processor is also configured to:
determine whether a second radio broadcast message is received in a preset time period;
after determining that the second radio broadcast message is not received in a preset time period, switch from the second operation state to the first operation state.

19. A mobile device, comprising:
a processor; and
a memory storing an instruction executable by the processor,
wherein the processor is configured to:
acquire one or more unique identifiers of one or more wearable devices, wherein the one or more wearable devices includes at least one of: a first wearable device that is in a binding relationship with the mobile device, and a second wearable device communicatively coupled with the mobile device; and
transmit at least one of the one or more unique identifiers to an appliance to cause the appliance to store the at least one of the one or more unique identifiers, and to execute a preset operation command after receiving a radio broadcast message containing the at least one of the one or more unique identifiers.

20. A wearable device, comprising:
a processor; and
a memory storing an instruction executable by the processor,
wherein the processor is configured to:
transmit, periodically to an appliance, a radio broadcast message containing a unique identifier of the wearable device;
wherein the radio broadcast message causes the appliance to execute a preset operation command if the unique identifier contained in the radio broadcast message matches with a stored identifier at the appliance.
